(19) United States
(12) Patent Application Publication
(10) Pub. No.: US 2004/0204974 A1
(43) Pub. Date: Oct. 14, 2004

(54) Method of and system for gathering organisational information

(76) Inventors: Robert J. Prinable, Fairlight (AU); Peter Hojgaard-Olsen, Manly Vale (AU)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/477,045

(22) PCT Filed: May 9, 2002
(86) PCT No.: PCT/AU02/00577

(30) Foreign Application Priority Data
May 10, 2001 (AU) PR 8138

(51) Int. Cl. G06F 17/60

(52) U.S. Cl. 705/7

(57) ABSTRACT

A system for and method of gathering organisational information is disclosed. The system (10) includes a data gathering application (12) and a graphics rendering application (16). The data gathering application (12) arranged to gather from individuals associated with the organisation subjective output data indicative of outputs produced by the individual. The data gathering application (12) is also arranged to gather from individuals associated with the organisation subjective parameter data indicative of at least one parameter associated with each output. The graphics rendering application (16) is arranged to represent at least two of the individuals, at least one of the outputs and at least one parameter associated with the at least one output in a graphical format.

### FIELD OF THE INVENTION

The present invention relates to a method of and system for gathering organisational information.

### BACKGROUND OF THE INVENTION

It is known to analyse the performance of an organisation by focusing on and gathering information relating to the financial performance of the organisation. However, while this provides an indication as to whether the organisation is financially profitable, it does not give any indication as to the performance of specific processes within the organisation, as to the performance of specific individuals within the organisation, or as to the potential of individuals within the organisation. As a result, aspects of the organisation which contribute to the performance of the organisation as a whole are neglected in the analysis process.

Further, by only analysing financial reports of the organisation, the responsible management personnel within the organisation are effectively analysing the status of the organisation as it was at some time previously (often months or years). For this reason, financial reports are often referred to as “lagging indicators' of organisation health.

There is a need for an arrangement which would at least provide an alternative to the above approach.

Definitions

In this specification, the following definitions apply:

Output—the result or outcome of work done by an individual associated with an organisation.

Input—the result or outcome of work received by an individual associated with an organisation.

Link—The relationship between two individuals in which the output of one is the input of another.

Link dependency—the relationships between links that defines which input links must be completed before a particular output link can be completed.

Process—a collection of one or more links, done by one or more individuals.

### SUMMARY OF THE INVENTION

In accordance with a first aspect the present invention provides a method of gathering organisational information, said method including the steps of: identifying individuals associated with the organisation; gathering from each individual subjective output data indicative of outputs produced by the individual; for each output produced by an individual, gathering from that individual subjective parameter data indicative of at least one parameter associated with the output.

Preferably, the method further includes the step of representing at least two of the individuals, at least one of the outputs and at least one parameter associated with the at least one output in a graphical format. This provides a convenient mechanism for analysing the gathered information.

Preferably, the step of gathering subjective output data includes the step of gathering from each individual a description of the output in words of the individuals choosing. Preferably, the description is in the form of a label.

Preferably, the step of gathering subjective parameter data includes the step of gathering from each individual for each output produced by that individual categorisation data indicative of the output type, of the output immediacy, or of the process to which the output belongs.

Preferably, the step of gathering subjective parameter data includes the step of gathering from each individual and for each output produced by that individual characteristics data indicative of constraints which are appropriate for the output or indicative of the frequency of the output.

Preferably, the step of gathering subjective parameter data includes the step of gathering from each individual and for each output produced by that individual ratings data indicative of a subjective scaled assessment of each output by the individual.

Preferably, said scaled assessment is based on pre-defined criteria.

Preferably, the criteria are assessed on a scale of 1 to 5.

Preferably, the method further includes the step of gathering from each individual subjective input data indicative of inputs received by the individual.

Preferably, the step of gathering subjective input data includes the step of gathering from each individual and for each input received by that individual rating data indicative of a subjective scaled assessment of each input by the individual.

Preferably, said scaled assessment is based on pre-defined criteria.

Preferably, the criteria are assessed on a scale of 1 to 5.

Preferably, the method further includes the step of gathering from each individual subjective process data, the process data serving to link outputs together in accordance with the appropriate processes to which the outputs belong.

Preferably, the method further includes the step of assessing data gathered from each individual.

Preferably, the assessment step includes the step of interrogating an individual when a pre-defined set of rules indicates that gathered data is likely to be incorrect.

Preferably, the assessment step includes the step of interrogating an individual when a pre-defined profile based on typical types of interactions between individuals indicates that gathered data is likely to be incorrect.

Preferably, the assessment step includes the step of interrogating an individual when gathered data falls outside a pre-defined quantitative limit.

Preferably, the representing step includes the step of representing at least two individuals as at least two respective nodes.

Preferably, the representing step includes the step of representing the at least one output as at least one respective link.

Preferably, the representing step includes the step of colour coding the at least one link such that the colour of the at least one link represents a category, characteristic or criterion rating.

Preferably, the representing step includes the step of width coding the at least one link such that the width of the at least one link represents a category, characteristic or criterion rating.

Preferably, the method further includes the step of facilitating filtering of data gathered from the individuals such that only a user defined group of individuals are represented in the representing step.

Preferably, the method further includes the step of facilitating filtering of data gathered from the individuals such that only a user defined group of outputs are represented in the represented step.

Preferably, the method further includes the step of providing a computer terminal for facilitating the data gathering step.

Preferably, the individuals are either of an employee of the organisation, stakeholder of the organisation, supplier associated with the organisation or customer associated with the organisation.

Preferably, the representing step includes the step of representing the gathered data in a three-dimensional graphical format.

Preferably, the representing step includes the step of representing the gathered data in the shape of a polyhedron such as an octahedron or cone shaped polyhedron.

Preferably, the representing step includes the step of representing the gathered data in a two dimensional format.

In a second aspect the present invention provides a system for gathering organisational information, said system including: a data gathering application being arranged to gather from individuals associated with an organisation subjective output data indicative of outputs produced by each individual; for each output produced by an individual said data gathering application being arranged to gather from that individual subjective parameter data indicative of at least one parameter associated with the output.

Preferably, the system further includes a graphics rendering application being arranged to represent at least two of the individuals, at least one of the outputs and at least one parameter associated with the at least one output in a graphical format.

Preferably, the data gathering application is arranged to gather from each individual a description of the output in words of the individuals choosing. Preferably, this is gathered in the form of a label.

Preferably, the data gathering application is arranged to gather from each individual for each output produced by that individual categorisation data indicative of the output type, of the output immediacy, and/or of the process to which the output belongs.

Preferably, the data gathering application is arranged to gather from each individual and for each output produced by that individual characteristics data indicative of constraints which are appropriate for the output or indicative of the frequency of the output.

Preferably, the data gathering application is arranged to gather from each individual and for each output produced by that individual ratings data indicative of a subjective scaled assessment of each output by the individual.

Preferably, said scaled assessment is based on pre-defined criteria.

Preferably, the criteria are assessed on a scale of 1 to 5.

Preferably, the data gathering application is arranged to gather from each individual subjective input data indicative of inputs received by that individual.

Preferably, the data gathering application is arranged to gather subjective input data from each individual and for each input received by that individual rating data indicative of a subjective scaled assessment of each input by the individual.

Preferably, said scaled assessment is based on pre-defined criteria.

Preferably, the criteria are assessed on a scale of 1 to 5.

Preferably, the data gathering application is arranged to gather from each individual subjective process data, the process data serving to link outputs together in accordance with the appropriate processes to which the outputs belong.

Preferably, the system further includes an assessment application arranged to assess data gathered from each individual.

Preferably, the assessment application is arranged to interrogate an individual when a pre-defined set of rules indicates that gathered data is likely to be incorrect.

Preferably, the assessment application is arranged to interrogate an individual when a pre-defined profile based on typical types of interactions between individuals indicates that gathered data is likely to be incorrect.

Preferably, the assessment application is arranged to interrogate an individual when gathered data falls outside a pre-defined quantitative limit.

Preferably, the graphics rendering application is arranged to represent the at least two individuals as at least two respective nodes.

Preferably, the graphics rendering application is arranged to represent the at least one output as at least one respective link.

Preferably, the graphics rendering application is arranged to colour code the at least one link such that the colour of the at least one link represents a category, characteristic or criterion rating.

Preferably, the graphics rendering application is arranged to width code the at least one link such that the width of the at least one link represents a category, characteristic or criterion rating.

Preferably, the system is arranged to facilitate filtering of data gathered from individuals associated with an organisation such that only a user defined group of individuals are represented by the graphics rendering application.

Preferably, the system is arranged to facilitate filtering of data gathered from individuals associated with an organisation such that only a user defined group of outputs are represented by the graphics rendering application.

Preferably, the system further includes a computer terminal for facilitating the data gathering step.

Preferably, each individual is an employee of the organisation, stakeholder of the organisation, supplier associated with the organisation or customer associated with the organisation.

Preferably, the graphics rendering application is arranged to represent the gathered data in a three-dimensional graphical format.

Preferably, the graphics rendering application is arranged to represent the gathered data in the shape of a polyhedron such as an octahedron or cone shaped polyhedron.

Preferably, the graphics rendering application is arranged to represent the gathered data in a two dimensional format.

In a third aspect the present invention provides a method of graphically representing organisational information, said method including the steps of: receiving subjective output data gathered from individuals associated with the organisation, said output data being indicative of outputs produced by each individual; for each output, receiving subjective parameter data gathered from each individual, said parameter data being indicative of at least one characteristic associated with the output; and graphically representing at least two of the individuals; at least one of the outputs and at least one parameter associated with the at least one output in a graphical format.

In a fourth aspect the present invention provides a system for graphically representing organisational information, said system including: a graphics rendering application; said graphics rendering application being arranged to receive subjective output data gathered from individuals associated with the organisation, said subjective output data being indicative of outputs produced by each individual; said graphics rendering application being arranged to receive subjective parameter data from each individual, said subjective parameter data being indicative of at least one characteristic associated with each output; and said graphics rendering application being arranged to represent at least two of the individuals, at least one of the outputs and at least one parameter associated with the at least one output in a graphical format.

In a fifth aspect the present invention provides a computer program arranged, when loaded onto a computer system, to instruct the computer system to operate in accordance with a method according to either the first or the third aspect of the invention.

In a sixth aspect the present invention provides a computer useable medium having a computer program according to the fifth aspect of the invention embodied therein.

### BRIEF DESCRIPTION OF THE DRAWINGS

The present invention will now be described, by way of example only, with reference to the accompanying drawings, in which:

FIG. 1 is a block diagram of a system for gathering organisational information in accordance with an embodiment of the present invention;

FIG. 2 is a flow diagram showing steps of gathering output data from an individual associated with an organisation, the steps being part of a method in accordance with an embodiment of the present invention; and

FIGS. 3 to 18 show screens of the system of FIG. 1.

### DESCRIPTION OF A PREFERRED EMBODIMENT OF THE PRESENT INVENTION

In the following description of an embodiment of the invention, it will be understood that the invention may be implemented as hardware and/or software using an appropriate platform such as a computing system.

The present invention broadly relates to a system and corresponding method which enables subjective data, including qualitative and quantitative data, relating to outputs produced by individuals associated with an organisation to be collected in a rapid and accurate manner. Thereafter, the collected information may be analysed to identify problem areas and areas where the organisation may be improved. To facilitate analysis the collected data may be used to create a graphical representation of inter-relationships between individuals associated with the organisation.

For example, if a first individual produces an output which is perceived by the first individual to be of little importance to the organisation as a whole, but a second individual who receives the output perceives the output to be of relatively high importance to the organisation as a whole, there is a potential problem. By analysing the collected information, particularly when represented graphically, this mismatch of perceptions is perceivable by the relevant personnel.

It will be understood that an individual may be associated with an organisation because the individual is an employee of the organisation, because the individual is a stakeholder in the organisation, or because the individual is a supplier or customer of the organisation.

The system operates by gathering data from individuals associated with the organisation, the gathered data being representative of actions carried out by those individuals which add value to the organisation.

A preferred embodiment of the invention will now be described. This embodiment has particular application where the organisation is a business and is described in these terms. It will be appreciated that the invention is not limited to use in analysing businesses and is equally applicable to organisations such as not for profit organisations, government departments and the like.

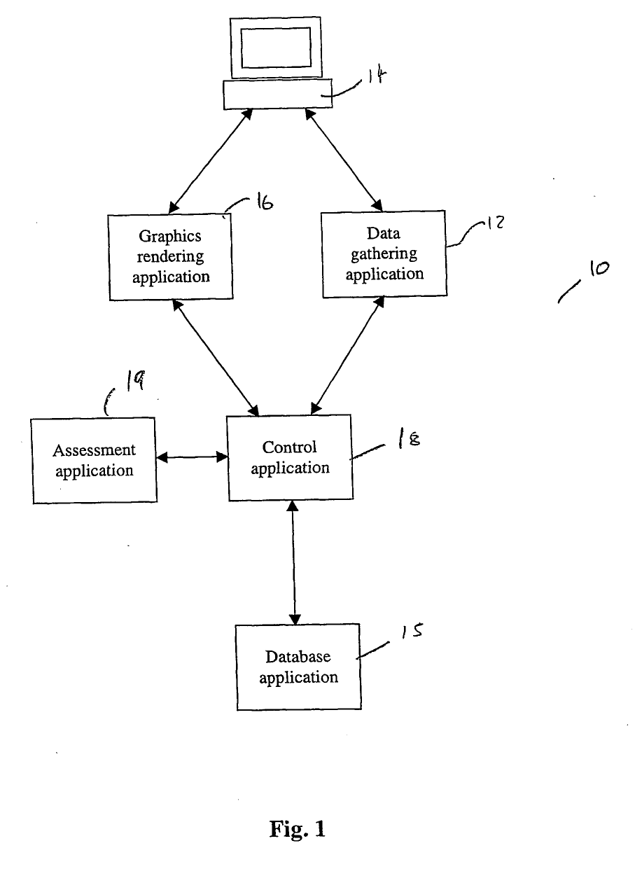

Referring to the drawings, in FIG. 1 there is shown a system 10 for gathering organisational information where the organisation is a business. The system 10 gathers and represents information relating to inter-relationships between individuals associated with the business. The system 10 includes a data gathering application 12 and a computer terminal 14 for gathering data from an individual associated with the business. The system 10 also includes a database application 15 for storing gathered data, and a graphics rendering application 16 for processing the data stored in the database application 15 and for graphically representing at least some of the stored data on the computer terminal 14.

Also included in the system 10 is a control application 18 which is arranged to control and coordinate the transfer of information between the data gathering application 12, the database application 15 and the graphics rendering application 16.

The system 10 also includes an assessment application 19 which is arranged to assess the data gathered from an individual.

The data gathering application 12 is arranged to facilitate reception of data relating to the activities of an individual in the business which add value. In particular, the data gathering application 12 facilitates identification of an individual, reception of information indicative of the outputs which are supplied by the individual, reception of information indicative of the recipients of the outputs produced by the individual, reception of information identifying how frequently each output is produced, and reception of subjective information indicative of the individual's subjective assessment of various parameters and criteria associated with the outputs.

Using the data gathering application 12 and the computer terminal 14, each output produced by an individual is categorised by giving the output a label which describes the action in words understandable to the individual such as “Monthly Sales Report” or “Management—Coaching and Supervision”.

This ensures that data is gathered which represents what the individual actually does, not what the individual is perceived by others to do.

Using the data gathering application 12 and the computer terminal 14, each output is also categorised by the individual by selecting from a pre-defined list of output types. Each output type describes a type of value add action which may be carried out by an individual such as “Information—Written”, “Information—Verbal”, “Formal Report”, “Management”, and so on. The individual then uses the data gathering application 12 and the computer terminal 14 to categorise the immediacy of the action by selecting from a pre-defined list. Each item in the immediacy list gives an indication of the time frame with which the output is concerned such as “present time action”, strategic planning/goal setting” and so on.

Following appropriate labelling and categorisation of an output, the output is characterised by the individual selecting from pre-defined lists of characteristics which may be properly associated with an output. The characteristics include selectable qualifiers which define constraints which are appropriate for the output such as “Accurate”, “Innovative”, “Timely”, and so on. The characteristics also include selectable qualifiers which provide an indication as to how frequently an output is produced.

The appropriate process is also selected from a pre-defined list of processes, an appropriate process being selected when an output properly belongs to the process. Such predefined processes may be for example, “Marketing—Budget”, “Logistics—Shipping and Deliveries”, “IT—Network Administration”, and so on.

The categories and characteristics are referred to collectively in this specification as “parameters”.

Following appropriate characterisation of the outputs, the outputs are rated using pre-defined criteria. In this embodiment, the criteria which are rated are as follows:

Personal satisfaction with the output;

Importance of the output in relation to other outputs;

Whether opportunities exist to improve the output;

Value of the output to the business as a whole; and

Time spent in producing and delivering the output.

Of course, however, other or additional criteria may be used to describe each output depending on the business involved.

Each criterion is rated by the individual on a graduated scale, in this embodiment a numeric scale from 1 to 5. For example, in this embodiment, for the “personal satisfaction” category, the ratings are defined as follows:

1—Most dissatisfying tasks;

2—Significant dissatisfaction with these tasks;

3—These tasks are ok;

4—Significant satisfaction in these tasks;

5—Most satisfying tasks.

It will be understood that for the importance criterion, the rating is based on a principle that not all tasks carried out by an individual are of equal importance to the individuals job. Using the importance criterion, an individual is able to distinguish between outputs which are perceived by the individual as important and outputs which are perceived by the individual as non-important.

It will also be understood that for the improvement criterion, the individuals do not describe what can be changed. Instead, emphasis is placed on whether scope is present for improvement. The improvement ratings may be used by the individuals to self-manage a personal improvement process by identifying outputs which have been rated poorly by the receiving individuals.

In addition to facilitating rating by an individual of criteria associated with outputs produced by an individual, the system is also arranged to facilitate rating by an individual of criteria associated with inputs received by the individual from other individuals associated with the business. In this embodiment, the criteria which are rated are as follows:

1. Satisfaction of the input received;

2. Importance of the input to the receiving individual's job.

Likewise with the output criteria, the input criteria are rated on a scale of 1 to 5. An example of the ratings which may be applied to the “satisfaction” input criterion are as follows:

1—Urgent improvement required;

2—Some improvement required;

3—OK—meets requirement;

4—Above average service; and

5—Excellent service.

Following gathering of the above output related data, the individual's outputs are linked together with outputs of other individuals in accordance with the processes to which they belong. This is done by first selecting a general business process such as “Finance and Accounting”, by selecting a more specific business process within the general business process such as “Accounts Payable—Purchasing”, then by identifying any link dependencies, that is, which outputs from other individuals are required in order to produce each output associated with the selected specific process. In this way, each output is placed in context in relation to the processes in the business with which the output is associated. This allows analysis of specific business processes and supply chains and in this way provides management with up-to-date information which may be used for business process re-design.

It is important that the data gathered by the system is normalised as far as possible. This ensures that the data received from various individuals can be reliably compared and improves the reliability of analysis performed on the gathered data. A primary source of variance from normalcy is that different individuals will provide information at differing levels of detail. For example, a chauffeur may consider that they provide outputs in the form of “washing the vehicle”, “buying petrol” and “checking the tyres”. Whereas the person being driven by the chauffeur regards all three of these as “vehicle maintenance”.

Normalisation is effected in a number of ways.

The accuracy of data gathering can be increased by subjecting each individual to a self-management process included in training software. By tailoring the self-management process so that the individuals understand the significance of the gathered data, the individuals can be encouraged to enter data honestly. For example, by explaining to individuals that if outputs received from a superior individual within the organisation are rated highly because of a fear of upsetting the superior individual, but the individuals outputs are rated as average, it will appear to management that the standard of the individuals work is poor in relation to the standard of the superior individuals work.

Rules are defined in assessment application 19 that are specific to the level that an individual occupies in an organisational hierarchy. If the data provided by an individual breaks these rules then the individual is asked to verify the data they provided.

The rules defined in assessment application 19 are adaptive. They are modified according to the use of the system. For instance, assessment application may record characteristics of data gathered from many individuals who are receptionists. If another individual provides data that differs significantly from the previous receptionists then they may be asked to verify their data.

The recipient of a link may evaluate what an individual has recorded as their output and correct it.

A user of the system such as a project manager may be given the authority to adjust the data provided by individuals under the supervision of that manager.

If a high number of links are associated with an individual compared with individuals performing similar roles then this may indicate that that individual has provided too great a level of detail.

The system may provide an individual with examples showing the required level of detail.

The various normalising mechanisms may alert an individual to a potential discrepancy in the gathered data. However, the individual may proceed and insist that the data they have provided is correct.

The system may allow a user to grade data including but not limited to time periods into colour coded bands. For example, red is 0 to 10 hours, yellow is 10 to 20 hours. This should not be done if a time and motion study is to be carried out on the collected data. Accurately recorded time periods are required for such an analysis.

The system has a built in mitigation mechanism that allows two individuals to maintain different views of what a single link is and of the appropriate level of detail for that link. Merely identifying such a discrepancy may highlight an inefficiency in the operation of the organisation that can then be investigated. If the discrepancy is resolved, either party may make the change to bring the data into conformity, the other party may be required to re-visit the data to accept the change.

The above mentioned gathered data is stored in the database application 15 by the control application 18 and may be retrieved by the control application 18 for use by the graphics rendering application 16.

The graphics rendering application 16 is arranged to utilise the gathered data stored in the database application 14 to create a graphical representation of inter-relationships between the individuals associated with the business on the computer terminal 14. The graphical representation includes nodes and links. The nodes represent an individual in the business. Typically, each individual will be represented by one node. If an individual has more than one role in the business then a node may be used to represent each of those roles. The links which extend between nodes represent the outputs.

By coding each link such that the colour of the link and the thickness of the link each represents one of the criteria ratings, or one of the parameters, management are able to view information indicative of inter-relationships between individuals in a concise way.

The graphics rendering application 16 is also arranged such that the information displayed on the computer terminal 14 is filterable so that a user is able to view selected information, such as information relating to a specific process in the business, or to view only specific individuals within the business, and so on.

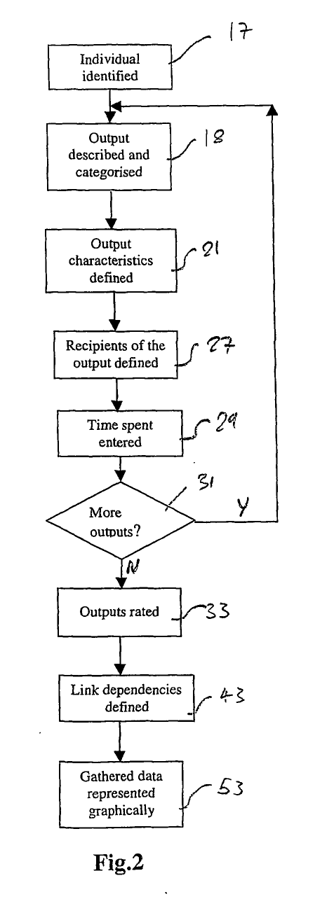

Referring to FIGS. 2 to 18, the present system will now be described in operation.

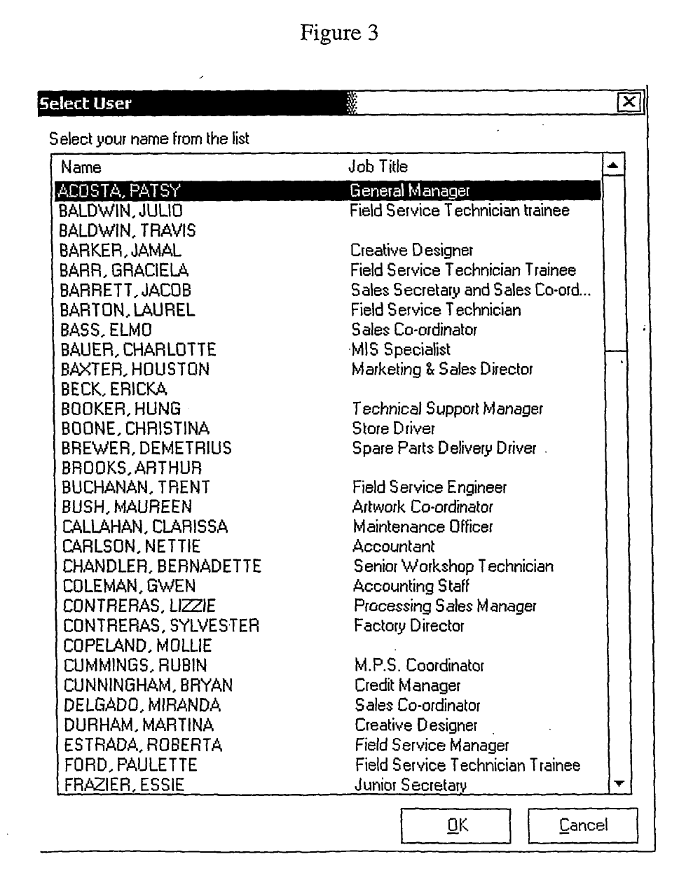

In order for an individual associated with the business to define the outputs which the individual produces, the individual must first provide the system 10 with information which identifies the individual, as indicated at step 17 of the flow diagram in FIG. 2. This may be done by the individual logging into the system or by selecting from a list of individuals associated with the business as shown in FIG. 3.

Once the individual has been identified, an output produced by the individual is described and categorised, as indicated at step 18 of the flow diagram of FIG. 2.

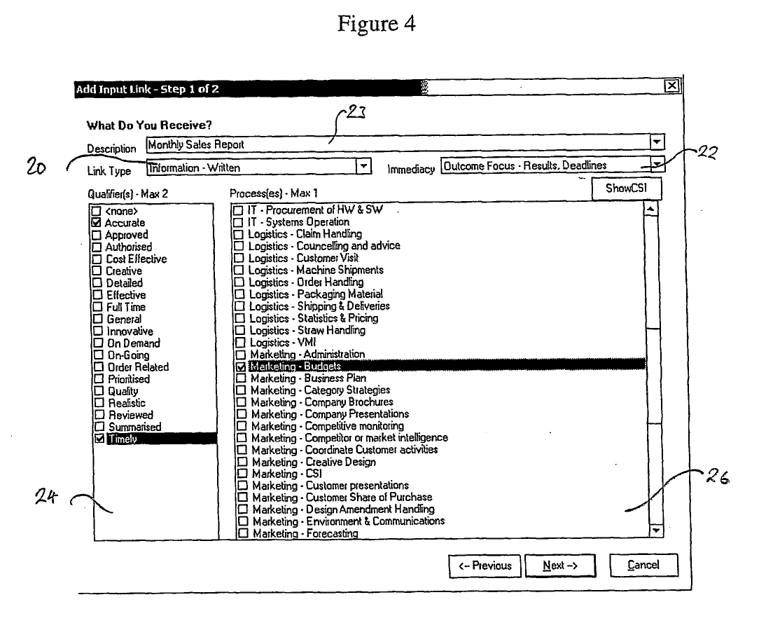

For each output produced by the individual, the individual enters a description in words of the individuals own choosing into a description box 23 as shown in FIG. 4. The individual then categorises the output using the screen shown in FIG. 4. In this embodiment, the individual categorises the output type by selecting a category from a plurality of categories in a link type box 20, and categorises the immediacy of the output by selecting from a plurality of statements in an immediacy box 22.

As indicated at step 21 in FIG. 2 and as shown in FIG. 4, following appropriate description and categorisation of the output, the individual defines characteristics of the output by choosing one or more qualifiers from a qualifier box 24 to define requirements for the output, and chooses an appropriate process to which the output properly belongs by selecting from a pre-defined list of processes in a process box 26.

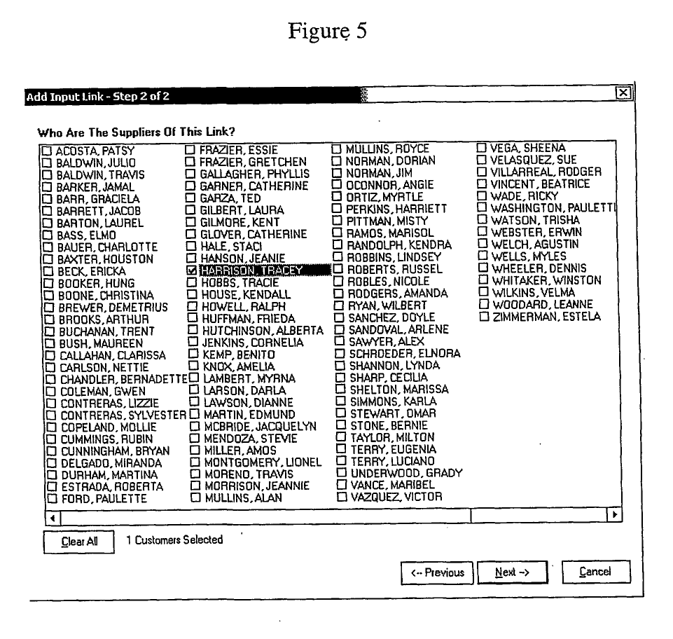

The individual is then presented with a screen as shown in FIG. 5. At this screen, as indicated at step 27 of the flow diagram in FIG. 2, the individual selects the other individuals associated with the business to which the output is supplied.

In some cases the individual may not know the actual name of the person who receives the output, such as in the case of an individual interacting with a computer system such as an accounting computer system. In this case, the system 10 may be able to identify the recipient from the process information provided by the individual. For example, any processes requiring input to the accounting computer system is deemed to be received by the manager of the accounts department.

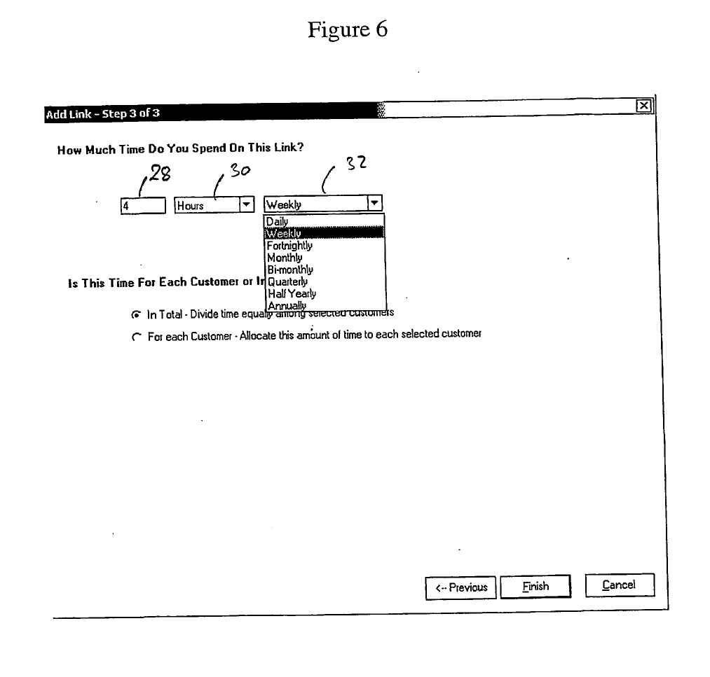

The individual is then presented with the screen shown in FIG. 6 and, as indicated at step 29 of the flow diagram in FIG. 2, the individual enters the appropriate frequency information by entering the appropriate time in time box 28 and time dropdown boxes 30 and 32. The frequency information constitutes a further characteristic of the output.

The above process for entering and defining outputs for an individual is repeated for each output until data for all outputs produced by the individual has been entered, as indicated at step 31 of the flow diagram in FIG. 2.

Once all outputs for an individual have been defined for the individual, the individual evaluates the inputs with which the individual is associated so that each input is verified by the individual as correct. In some situations, an individual may disagree with one or more input with which the individual has been associated. In such cases, the discrepancy may be resolved in a number of ways. The opinion of the receiving individual may be considered correct, the latest change by either individual may be taken to be correct, or the sending individual may have to accept changes made by the receiving party.

The individual must then rate the outputs as indicated at step 33 of the flow diagram in FIG. 2, so that each output is rated on the basis of various criteria.

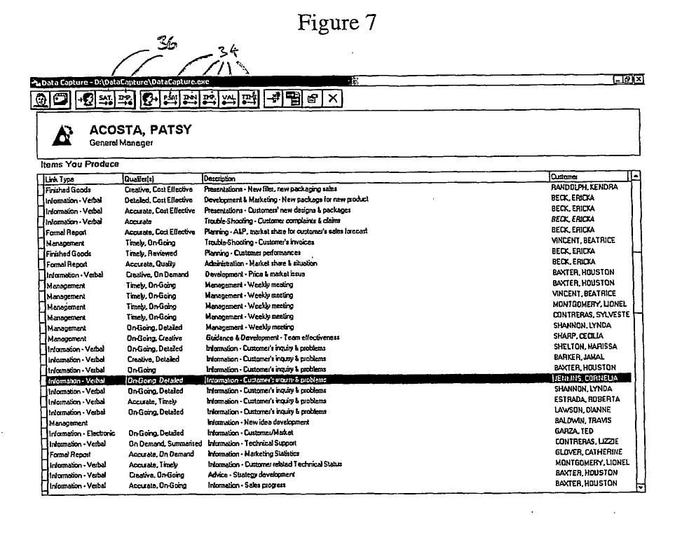

In FIG. 7, there is shown a screen which identifies all outputs for an individual associated with the business. The criteria used for rating outputs are described above and each output criterion is rated by activating an appropriate output rating icon 34.

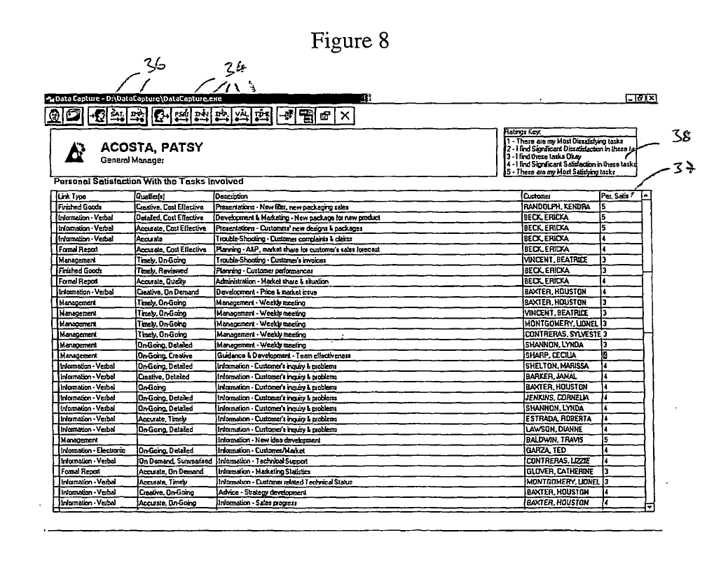

For example, when an output rating icon 34 corresponding to personal satisfaction is activated, a screen as shown in FIG. 8 is displayed. This screen corresponds to the screen shown in FIG. 7 except that an additional personal satisfaction column 37 headed “Per.Satis” is included together with a ratings key box 38. At this screen, the individual enters into the personal satisfaction column 37 the appropriate number from the ratings key box 38 which best corresponds with the most appropriate rating perceived by the individual for each output.

Each individual also rates input criteria, the criteria used for rating the inputs being as described above. Each input criterion is rated by activating an appropriate input rating icon 36.

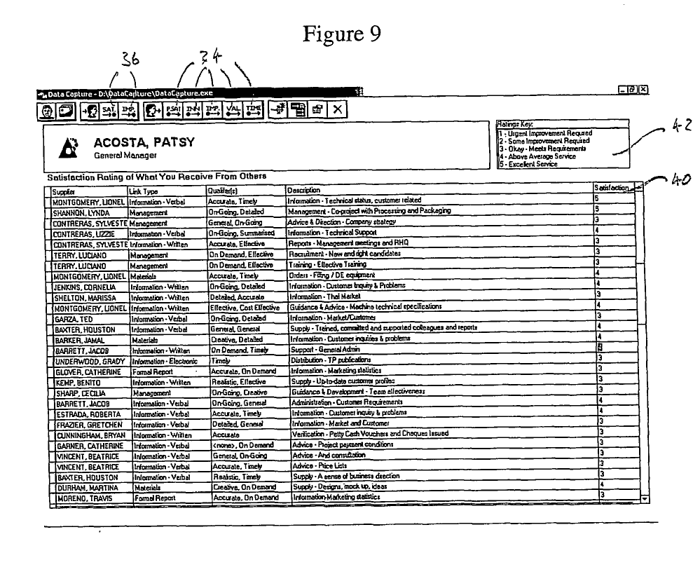

For example, when an input rating icon 36 corresponding to “satisfaction” is activated a ratings screen display as shown in FIG. 9 is displayed. This screen lists the outputs received by the individual and includes a satisfaction column 40 together with a ratings key box 42. As with the output ratings screen, the individual selects the most appropriate number from the ratings key box 42 which is believed by the individual to apply to each received output.

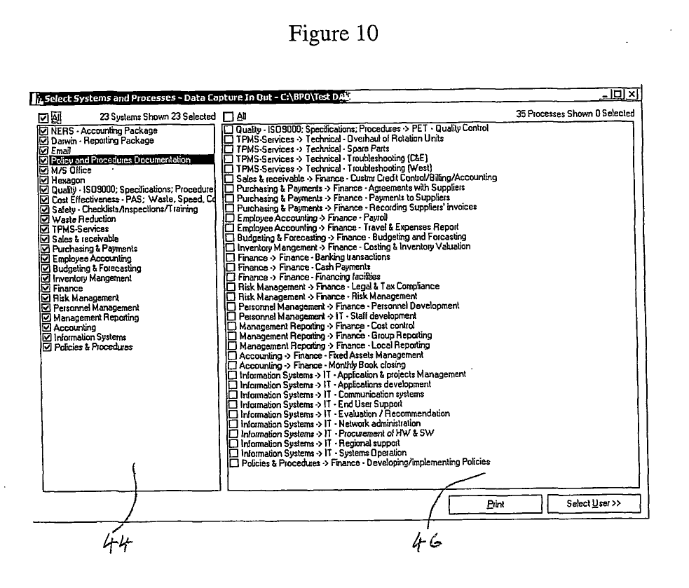

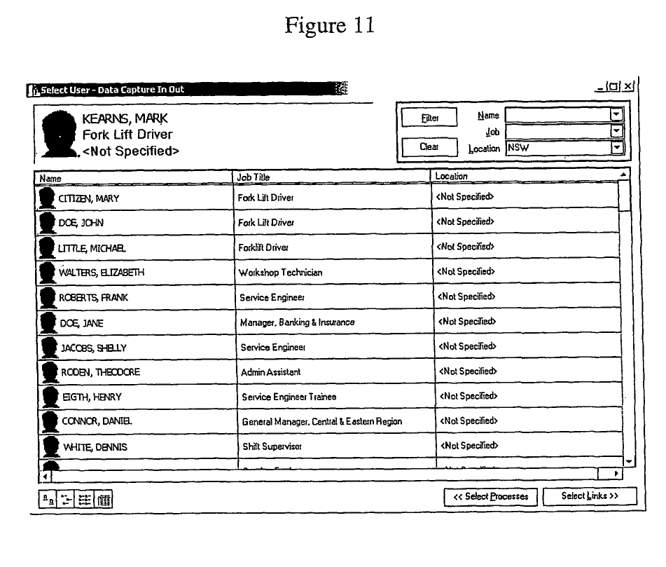

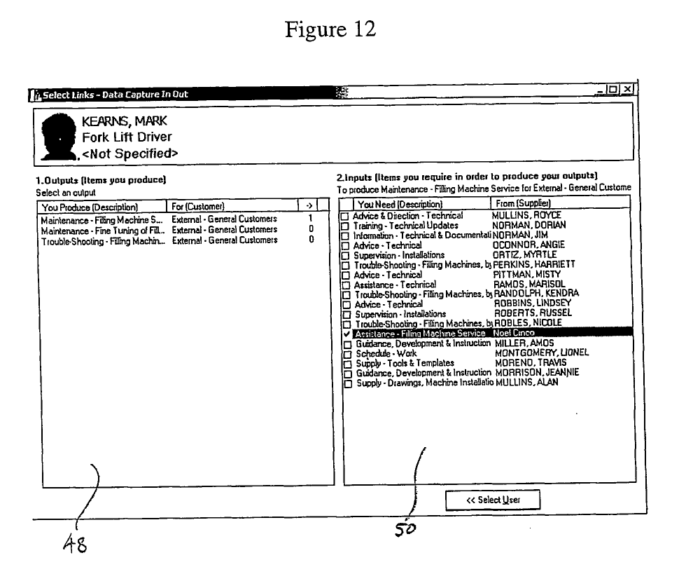

As an optional step, the individual uses screens as shown in FIGS. 10 to 12 to define link dependencies at step 43. The entered outputs are linked together into the appropriate processes to which they belong. This is done by selecting from the screen in FIG. 10 the appropriate process from a process box 46. After selecting a process, the individual is presented with a list of individuals associated with that process, as shown in FIG. 11. For each of the individual's outputs which are associated with the selected process, the individual must identify the outputs from other individuals which must be received in order to produce their output. As shown in FIG. 12, this is done by selecting an output produced by the individual from an output box 48, and selecting from inputs box 50 the outputs produced by other individuals which are required for production of the selected output. This process is repeated for each output produced by the individual.

The defining of link dependencies allows for the production of time and motion studies and the creation of activity flow diagrams. By selecting certain links in a process the link dependencies will determine the “flow” through these links. It is also possible to determine bottlenecks and to calculate time from start to completion of a given series of links.

At step 74 of FIG. 2 the gathered data is assessed for the purpose of normalising the data. To do this, the assessment application 19 assesses the data and alerts the individual if it assesses that the gathered data may not be correct. It does this in several ways.

Based on the relative position of the individual in the business, a set of rules is defined for interacting with the individual during data gathering. If entered data is considered to fall outside ranges of normalcy defined by the rules, the assessment application 19 generates a question or set of questions which are designed to assist the user to assess whether the entered data is correct. For example, if the individual carries out the role of office assistant in the business but enters activities that fall within the role of a strategic planner, it is most likely that the entered data is incorrect.

The output categories, the output characteristics and the ratings entered by the individual are assessed against the defined rules by the assessment application 19 and a determination is made as to whether they are likely to be accurate. Questions may be directed to the individual where necessary. Examples may be provided to the individual for assistance.

Entered data is also normalised based on a quantitative assessment. For example, if an individual enters data which suggests that the individual works for more than 100 hours per week, it is most likely that the individual has entered data incorrectly and the assessment application 19 generates an indication to this effect. All gathered data relating to the individuals associated with the business, the outputs produced by each individual, and the parameters applied to each output is stored in the database application 14 for subsequent analysis.

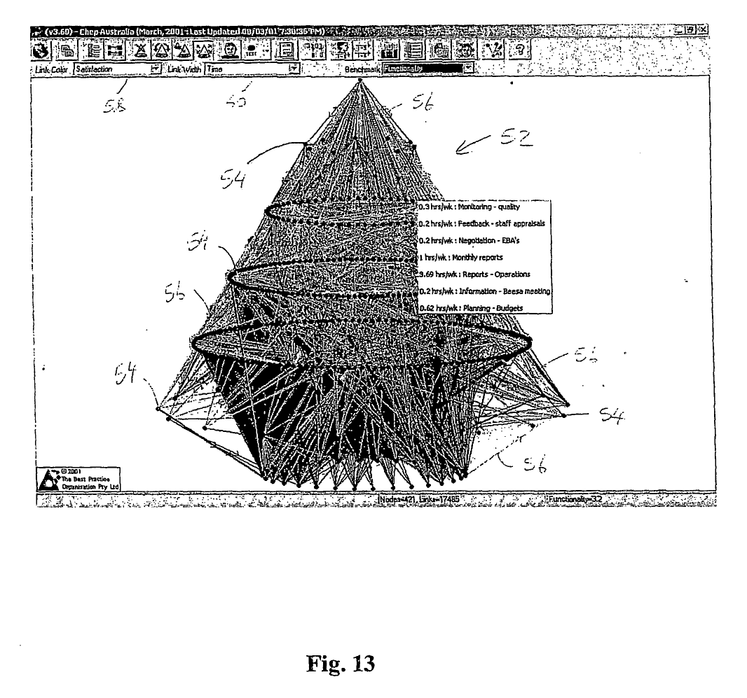

Using the graphics rendering application 16, the stored data may be displayed to a user as indicated at step 53 of the flow diagram in FIG. 2 in a variety of ways. For example, as shown in FIG. 13, there is shown a three dimensional graphical representation of inter-relationships of individuals associated with the business. The representation is in the form of a cone shaped polyhedron 52 with each node 54 of the cone representing an individual and each link 56 between individuals representing an output. As indicated by link colour box 58 and link width box 60, the link colour and the link width each correspond to one of the criteria rated by the individuals at the data entry stage. However, it will be understood that the link colour and link width may correspond to any other criteria or to any of the parameters associated with the outputs which have been gathered during the data gathering process. The parameter to be used for the link colour and link width are selectable using the link colour box 58 and link width box 60.

The graphics rendering application 16 is arranged to facilitate manipulation of the representation so that the cone 52 is viewable in a variety of ways. For example, the cone 52 may be rotated so as to view portions of the cone 52 not presently visible.

A three-dimensional representation such as the cone shaped polyhedron 52 is particularly suitable for representing organisational structures. However, other dimensional shapes are appropriate such as octahedrons, generally pyramidical shapes, and so on. In the example shown in FIG. 13 the different layers of nodes in the cone represent different layers in the hierarchy of the business.

The graphical representations produced by the graphics rendering application 16 on the computer terminal 14 may be modified at the option of a user to show pictures at the nodes such as photographs of the individuals, or to show a generic graphic at each node.

For relatively large businesses which have several associated individuals, the graphical representation is difficult to interpret. For this reason, the graphics rendering application 16 is arranged to filter the stored data so that only user selected data is displayed in the graphical representation.

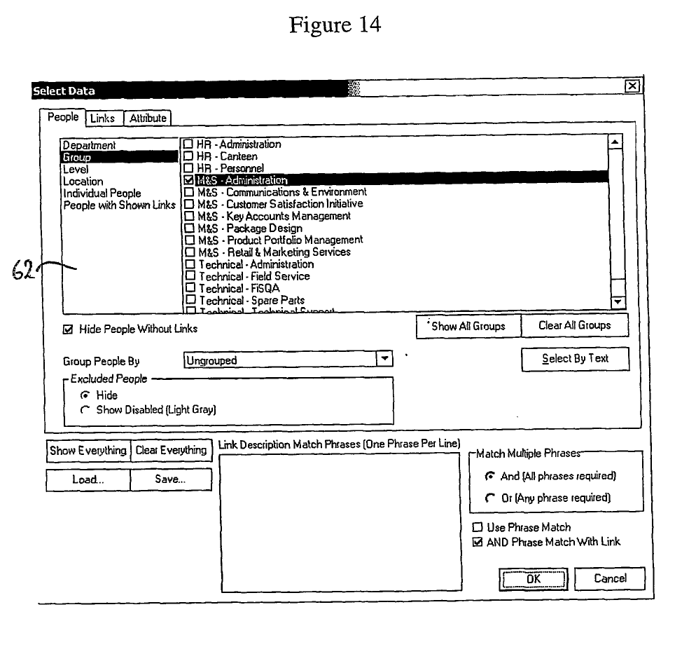

To display only selected information, a user first uses a screen as shown in FIG. 14 to select an appropriate group of individuals from a people box 62. As indicated, the selected group of individuals may range in size from a department to individual people.

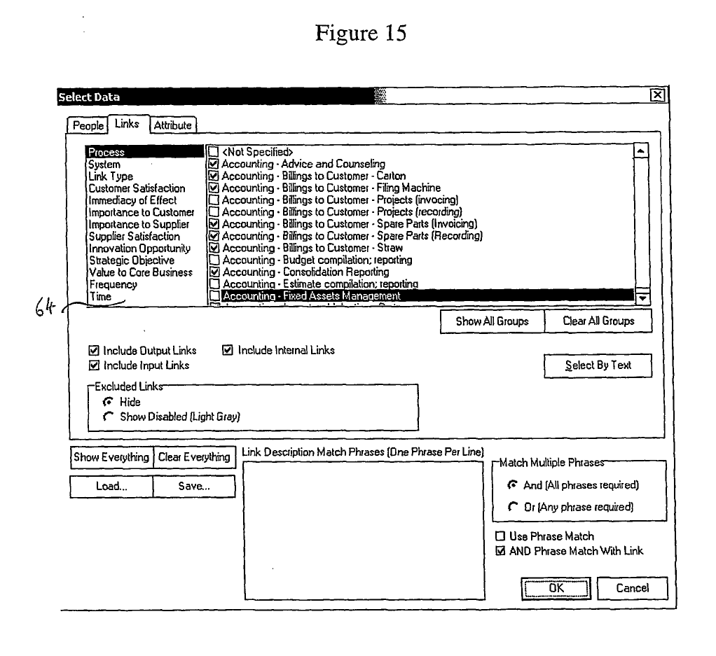

After selecting the appropriate group of individuals to be displayed, the outputs to be displayed are defined by selecting from a link box 64, as shown in FIG. 15.

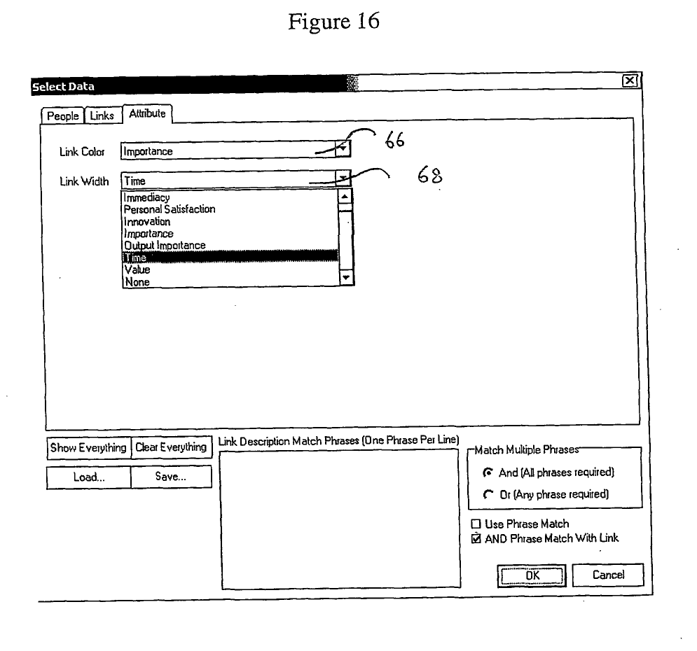

The parameters associated with the displayed links are then selected by choosing the appropriate parameters for the link colour and link width from a link colour box 66 and a link width box 68 shown in FIG. 16.

The example shown in FIG. 15 is a selection of outputs belonging to specific administration processes within the business. However, it will be understood that the outputs to be displayed may be selected on a different basis, for example so as to display all outputs which have a low customer satisfaction.

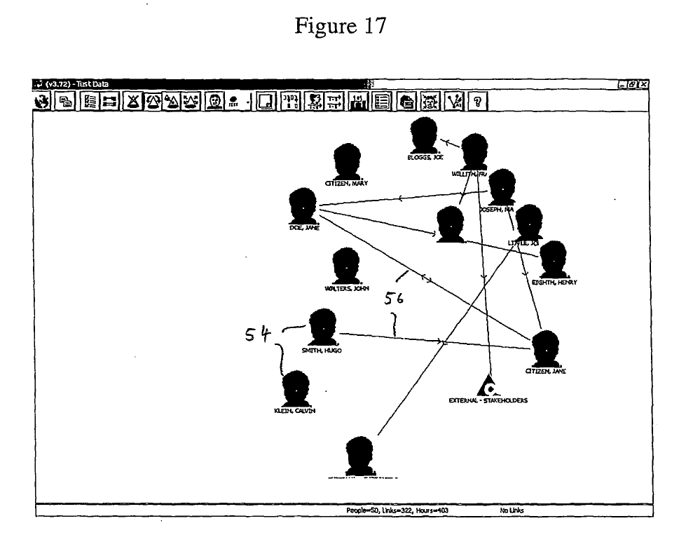

As a consequence of defining filter criteria for the stored data, a filtered representation 70 as shown in FIG. 17 can be displayed. As can be seen, the filtered representation 70 provides a more easily readable representation of inter-relationships between selected individuals associated with the business.

It will be understood that different types of filtering are possible and a user is able to select specific data for analysis. For example, the data represented on the computer terminal 14 may be restricted to specific departments, to subsidiary businesses in specific countries, to specific groups of individuals associated with the business, or to individuals carrying out specific jobs within the business, and so on.

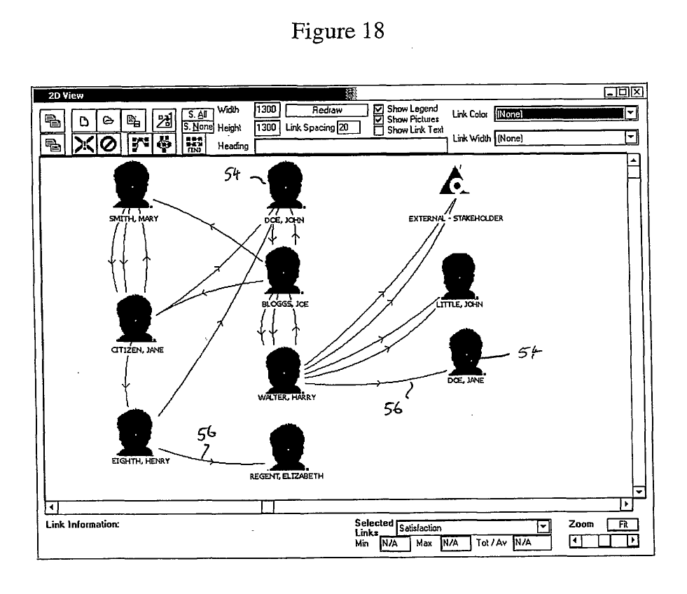

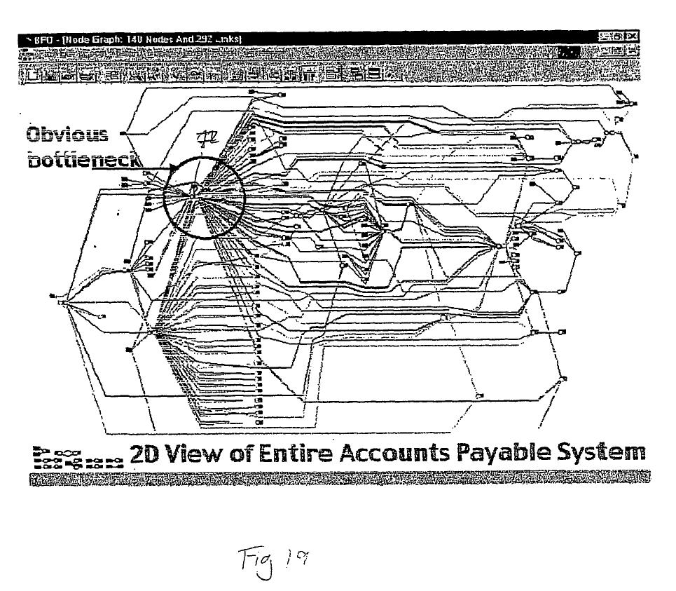

It will be understood that instead of representing the stored data or the filtered stored data in a three dimensional way, the stored data and filtered stored data may be represented in other ways, such as in two dimensions as shown in FIG. 18.

In FIG. 18, data which has been filtered is represented in a two dimensional way to show outputs associated with a particular selected process, with the entry points of the process being shown to the left of the screen and the exit points of the process being shown to the right of the screen.

An alternative to dimensional graphical representations is shown in FIG. 19. As with the flow diagram shown in FIG. 18 the entry points of the process are shown to the left of the screen and the exit points of the process are shown to the right of the screen. From this representation, it can easily be seen that a bottle neck is present at node 72 and appropriate corrective action such as increasing the number of individuals carrying out the role of node 72 is necessary.

It is possible to repeat the operation of the system at spaced intervals, such as every six months, and graphically depict how various parameters change over time. The repeated collection allows comparison between collection points to trend changes and assess the effects of changes that have been implemented.

Where methods and systems of the present invention may be implemented by software applications, or partly implemented by software, then they may take the form of program code stored or available from computer readable media, such as CD-ROMS or any other machine readable media, the program code comprising instructions which, when loaded into a machine such as a computer, the machine then becomes a system for carrying out the invention. The computer readable media may include transmission media, such as cabling fibre optics or any other form of transmission media.

It will be appreciated that by using the system for gathering and graphically representing organisational information in accordance with the present invention, the time required for individuals to enter the required data is relatively short compared to conventional organisational data gathering methods know hitherto.

It will also be appreciated that the representations generated by the system may be used for a variety of purposes such as for example balanced score card analysis, business process redesign, employee satisfaction surveys, customer satisfaction surveys, and so on.

Modifications and variations as will be apparent to a skilled addressee are deemed to be within the scope of the present invention.

1. A method of gathering organisational information, said method including the steps of:
identifying individuals associated with the organisation;
gathering from each individual subjective output data indicative of outputs produced by the individual; for each output produced by an individual, gathering from that individual subjective parameter data indicative of at least one parameter associated with the output.

2. A method according to claim 1 further including the step of representing at least two of the individuals, at least one of the outputs and at least one parameter associated with the at least one output in a graphical format.

3. A method as claimed in claim 1 wherein the step of gathering subjective output data includes the step of gathering from each individual a description of the output in words of the individuals choosing.

4. A method as claimed in claim 1, wherein the step of gathering subjective parameter data includes the step of gathering from each individual for each output produced by that individual categorisation data indicative of the output type, of the output immediacy, or of the process to which the output belongs.

5. A method as claimed in claim 1, wherein the step of gathering subjective parameter data includes the step of gathering from each individual and for each output produced by that individual characteristics data indicative of constraints which are appropriate for the output or indicative of the frequency of the output.

6. A method as claimed in claim 1, wherein the step of gathering subjective parameter data includes the step of gathering from each individual and for each output produced by that individual ratings data indicative of a subjective scaled assessment of each output by the individual.

7. A method as claimed in claim 6, wherein said scaled assessment is based on pre-defined criteria.

8. A method as claimed in claim 7, wherein the criteria are assessed on a scale of 1 to 5.

9. A method as claimed in claim 1, further including the step of gathering from each individual subjective input data indicative of inputs received by the individual.

10. A method as claimed in claim 9, wherein the step of gathering subjective input data includes the step of gathering from each individual and for each input received by that individual rating data indicative of a subjective scaled assessment of each input by the individual.

11. A method as claimed in claim 10, wherein said scaled assessment is based on pre-defined criteria.

12. A method as claimed in claim 11, wherein the criteria are assessed on a scale of 1 to 5.

13. A method as claimed in claim 1, further including the step of gathering from each individual subjective process data, the process data serving to link outputs together in accordance with the appropriate processes to which the outputs belong.

14. A method as claimed in claim 1, further including the step of assessing data gathered from each individual.

15. A method as claimed in claim 14, wherein the assessment step includes the step of interrogating an individual when a pre-defined set of rules indicates that gathered data is likely to be incorrect.

16. A method as claimed in claim 14, wherein the assessment step includes the step of interrogating an individual when a pre-defined profile based on typical types of interactions between individuals indicates that gathered data is likely to be incorrect.

17. A method as claimed in claim 14, wherein the assessment step includes the step of interrogating an individual when gathered data falls outside a pre-defined quantitative limit.

18. A method as claimed in claim 2, wherein the representing step includes the step of representing the at least two individuals as at least two respective nodes.

19. A method as claimed in claim 2, wherein the representing step includes the step of representing the at least one output as at least one respective link.

20. A method as claimed in claim 19, wherein the representing step includes the step of colour coding the at least one link such that the colour of the at least one link represents a category, characteristic or criterion rating.

21. A method as claimed in claim 19, wherein the representing step includes the step of width coding the at least one link such that the width of the at least one link represents a category, characteristic or criterion rating.

22. A method as claimed in claimed in claim 2 further including the step of facilitating filtering of data gathered from the individuals such that only a user defined group of individuals are represented in the representing step.

23. A method as claimed in claim 2, further including the step of facilitating filtering of data gathered from the individuals such that only a user defined group of outputs are represented in the represented step.

24. A method as claimed claim 1, further including the step of providing a computer terminal for facilitating the data gathering step.

25. A method as claimed in claim 1, wherein the individuals are either of an employee of the organisation, stakeholder of the organisation, supplier associated with the organisation or customer associated with the organisation.

26. A method as claimed in claim 2, wherein the representing step includes the step of representing the gathered data in a three-dimensional graphical format.

27. A method as claimed in claim 26, wherein the representing step includes the step of representing the gathered data in the shape of a polyhedron such as an octahedron or cone shaped polyhedron.

28. A method as claimed in claim 2, wherein the representing step includes the step of representing the gathered data in a two dimensional format.

29. A system for gathering organisational information, said system including:
a data gathering application being arranged to gather from individuals associated with an organization subjective output data indicative of outputs produced by each individual;
for each output produced by an individual said data gathering application being arranged to gather from that individual subjective parameter data indicative of at least one parameter associated with the output.

30. A system according to claim 29 further including a graphics rendering application being arranged to represent at least two of the individuals, at least one of the outputs and at least one parameter associated with the at least one output in a graphical format.

31. A system as claimed in claim 29, wherein the data gathering application is arranged to gather from each individual a description of the output in words of the individuals choosing.

32. A system as claimed in claim 29, wherein the data gathering application is arranged to gather from each individual for each output produced by that individual categorisation data indicative of the output type, of the output immediacy, and/or of than process to which the output belongs.

33. A system as claimed in claim 29, wherein the data gathering application is arranged to gather from each individual and for each output produced by that individual characteristics data indicative of constraints which are appropriate for the output or indicative of the frequency of the output.

34. A system as claimed in claim 29, wherein the data gathering application is arranged to gather from each individual and for each output produced by that individual ratings data indicative of a subjective scaled assessment of each output by the individual.

35. A system as claimed in claim 34, wherein said scaled assessment is based on pre-defined criteria.

36. A system as claimed in claim 35, wherein the criteria are assessed on a scale of 1 to 5.

37. A system as claimed in claim 29, wherein the data gathering application is arranged to gather from each individual subjective input data indicative of inputs received by that individual.

38. A system as claimed in claim 37, wherein the data gathering application is arranged to gather subjective input data from each individual and for each input received by that individual rating data indicative of a subjective scaled assessment of each input by the individual.

39. A system as claimed in claim 38, wherein said scaled assessment is based on pre-defined criteria.

40. A system as claimed in claim 39, wherein the criteria are assessed on a scale of 1 to 5.

41. A system as claimed in claim 29, wherein the data gathering application is arranged to gather from each individual subjective process data, the process data serving to link outputs together in accordance with the appropriate processes to which the outputs belong.

42. A system as claimed in claim 29, further including an assessment application arranged to assess data gathered from each individual.

43. A system as claimed in claim 42, wherein the assessment application is arranged to interrogate an individual when a pre-defined set of rules indicates that gathered data is likely to be incorrect.

44. A system as claimed in claim 42, wherein the assessment application is arranged to interrogate an individual when a pre-defined profile based on typical types of interactions between individuals indicates that gathered data is likely to be incorrect.

45. A system as claimed in claim 42, wherein the assessment application is arranged to interrogate an individual when gathered data falls outside a pre-defined quantitative limit.

46. A system as claimed in claim 30, wherein the graphics rendering application is arranged to represent the at least two individuals as at least two respective nodes.

47. A system as claimed in claim 30, wherein the graphics rendering application is arranged to represent the at least one output as at least one respective link.

48. A system as claimed in claim 47, wherein the graphics rendering application is arranged to colour code the at least one link such that the colour of the at least one link represents a category, characteristic or criterion rating.

49. A system as claimed in claim 47, wherein the graphics rendering application is arranged to width code the at least one link such that the width of the at least one link represents a category, characteristic or criterion rating.

50. A system as claimed in claim 30, wherein the system is arranged to facilitate filtering of data gathered from individuals associated with a organisation such that only a user defined group of individuals are represented by the graphics rendering application.

51. A system as claimed in claim 30, wherein the system is arranged to facilitate filtering of data gathered from individuals associated with a organisation such that only a user defined group of outputs are represented by the graphics rendering application.

52. A system as claimed in claim 29, further including a computer terminal for facilitating the data gathering step.

53. A system as claimed in claim 29, wherein each individual is an employee of the organisation, stakeholder of the organisation, supplier associated with the organisation or customer associated with the organisation.

54. A system as claimed in claim 30, wherein the graphics rendering application is arranged to represent the gathered data in a three-dimensional graphical format.

55. A system as claimed in claim 54, wherein the graphics rendering application is arranged to represent the gathered data in the shape of a polyhedron such as an octahedron or cone shaped polyhedron.

56. A system as claimed in claim 30, wherein the graphics rendering application is arranged to represent the gathered data in a two dimensional format.

57. A method of graphically representing organizational information, said method including the steps of:
receiving subjective output data gathered from individuals associated with the organisation, said output data being indicative of outputs produced by each individual;
for each output, receiving subjective parameter data gathered from each individual, said parameter data being indicative of at least one characteristic associated with the output; and
graphically representing at least two of the individuals, at least one of the outputs and at least one parameter associated with the at least one output in a graphical format.

58. A method as claimed in claim 57, wherein the representing step includes the step of representing the at least two individuals as at least two respective nodes.

59. A method as claimed in either claim 57, wherein the representing step includes the step of representing the at least one output as at least one respective link.

60. A method as claimed in claim 59, wherein the representing step includes the step of colour coding the at least one link such that the colour of the at least one link represents a category, characteristic or criterion rating.

61. A method as claimed in claim 59, wherein the representing step includes the step of width coding the at least one link such that the width of the at least one link represents a category, characteristic or criterion rating.

62. A method as claimed in claim 57, further including the step of facilitating filtering of data gathered from the individuals such that only a user defined group of individuals are represented in the representing step.

63. A method as claimed in claim 57, further including the step of facilitating filtering of data gathered from the individuals such that only a user defined group of outputs are represented in the represented step.

64. A method as claimed in claim 57, wherein the representing step includes the step of representing the gathered data in a three-dimensional graphical format.

65. A method as claimed in claim 64, wherein the representing step includes the step of representing the gathered data in the shape of a polyhedron such as an octahedron or cone shaped polyhedron.

66. A method as claimed in claim 57, wherein the representing step includes the step of representing the gathered data in a two dimensional format.

67. A system for graphically representing organizational information, said system including:
a graphics rendering application;
said graphics rendering application being arranged to receive subjective output data gathered from individuals associated with the organisation, said subjective output data being indicative of outputs produced by each individual;
said graphics rendering application being arranged to receive subjective parameter data from each individual, said subjective parameter data being indicative of at least one characteristic associated with each output; and
said graphics rendering application being arranged to represent at least two of the individuals, at least one of the outputs and at least one parameter associated with the at least one output in a graphical format.

68. A system as claimed in claim 67, wherein the graphics rendering application is arranged to represent the at least two individuals as at least two respective nodes.

69. A system as claimed in claim 67, wherein the graphics rendering application is arranged to represent the at least one output as at least one respective link.

70. A system as claimed in claim 69, wherein the graphics rendering application is arranged to colour code the at least one link such that the colour of the at least one link represents a category, characteristic or criterion rating.

71. A system as claimed in claim 69, wherein the graphics rendering application is arranged to width code the at least one link such that the width of the at least one link represents a category, characteristic or criterion rating.

72. A system as claimed in claim 67, wherein the system is arranged to facilitate filtering of data gathered from individuals associated with a organisation such that only a user defined group of individuals are represented by the graphics rendering application.

73. A system as claimed in claim 67, wherein the system is arranged to facilitate filtering of data gathered from individuals associated with a organisation such that only a user defined group of outputs are represented by the graphics rendering application.

74. A system as claimed in claim 67, wherein the graphics rendering application is arranged to represent the gathered data in a three-dimensional graphical format.

75. A system as claimed in claim 74, wherein the graphics rendering application is arranged to represent the gathered data in the shape of a polyhedron such as an octahedron or cone shaped polyhedron.

76. A system as claimed in claim 67, wherein the graphics rendering application is arranged to represent the gathered data in a two dimensional format.

77. A computer program arranged, when loaded onto a computer system, to instruct the computer system to operate in accordance with the method of claim 1.

78. A computer useable medium having a computer program according to claim 77 embodied therein.

79. (Canceled).

80. A computer program arranged, when loaded onto a computer system, to instruct the computer system to operate in accordance with the method of claim 57.

81. A computer useable medium having a computer program according to claim 80 embodied therein.
